(19) United States
(12) Patent Application Publication
(10) Pub. No.: US 2011/0076168 A1
(43) Pub. Date: Mar. 31, 2011

(54) PORTABLE INLINE PUMP KIT

(75) Inventors: Michael Howard IRVING, Haverhill, MA (US); Jeffrey Brian SCHOPPERLE, Wakefield, MA (US)

(73) Assignee: ITT MANUFACTURING ENTERPRISES, INC, Wilmington, DE (US)

(21) Appl. No.: 12/728,826

(22) Filed: Mar. 22, 2010

Related U.S. Application Data
(60) Provisional application No. 61/162,859, filed on Mar. 24, 2009.

(51) Int. Cl. F04B 35/04; H02J 7/00

(52) U.S. Cl. 417/410.1; 320/107

(57) ABSTRACT

A portable inline pump kit is provided featuring a pump having a fluid output port configured to pump fluid, and having a quick disconnect power input connection to couple the pump to a source of power; a portable battery or battery pack having a power connection to be coupled by wiring to the pump; a connector having a bullet connector to couple to the quick connect power input connection of the pump, and having another bullet connector to couple to the power connection of the portable battery or battery pack; an alligator style battery connector having a bullet connector to couple to the input connection of the pump, and having a pair of alligator style battery clips to couple to terminals of a battery, including a car or boat battery; a cigarette lighter connector having a bullet connector to couple to the power input connection of the pump, and having a cigarette lighter power adapter to be coupled to a remote cigarette lighter in, e.g. a boat, a car; and a carrying case having a top case portion hingeably coupled to a bottom case portion, wherein one case portion is configured to receive, frictionally engage and store one or more of the pump, the portable battery or battery pack, the connector, the alligator style battery connector or the cigarette lighter connector, and wherein the other case portion is configured to receive, frictionally engage and store the one or more of the pump, the portable battery or battery pack, the connector, the alligator style battery connector or the cigarette lighter connector not being stored in the one case portion.

### CROSS-REFERENCE TO RELATED APPLICATIONS

This application claims benefit to provisional patent application Ser. No. 61/162,859, filed 24 Mar. 2009, which is hereby incorporated by reference in its entirety.

### BACKGROUND OF THE INVENTION

The present invention relates to a pump kit.

### SUMMARY OF THE INVENTION

The present invention provides a portable inline pump kit, consisting of an inline pump capable of producing up to 280 gallons per hour. Wire leads on the end of an electric pump will have a quick disconnect plug which will allow a consumer to interchange between a pair of alligator style battery clips, a cigarette lighter power adaptor or to plug directly into a battery concealed in the hard plastic carry case. The kit will also contain a 8′ length of collapsible hose, a spray nozzle and a battery charger to recharge the battery.

According to some embodiments, the present invention may take the form of a portable inline pump kit comprising:

a pump having a fluid output port configured to pump fluid, and having a quick disconnect power input connection configured to couple the pump to a source of power;

a portable battery or battery pack having a quick disconnect power connection configured to be coupled by associated wiring to the quick disconnect power input connection of the pump;

a connector having the associated wiring with one corresponding quick disconnect plug or connection, e.g. a bullet connector, configured to couple to the quick connect power input connection of the pump, and with another corresponding quick disconnect plug configured to couple to the quick disconnect power connection of the portable battery or battery pack;

an alligator style battery connector having one corresponding quick disconnect plug or connection configured to couple to the quick disconnect power input connection of the pump, and having a pair of alligator style battery clips configured to be coupled to terminals of a battery, including a car or boat battery;

a cigarette lighter connector having one corresponding quick disconnect plug or connection configured to couple to the quick disconnect power input connection of the pump, and having a cigarette lighter power adapter configured to be coupled to a remote cigarette lighter in, e.g. a boat, a car, or some other equipment or device; and

a carrying case having a top case portion hingeably coupled to a bottom case portion, wherein one case portion is configured to receive, frictionally engage and store one or more of the pump, the portable battery or battery pack, the connector, the alligator style battery connector or the cigarette lighter connector, and wherein the other case portion is configured to receive, frictionally engage and store the one or more of the pump, the portable battery or battery pack, the connector, the alligator style battery connector or the cigarette lighter connector not being stored in the one case portion.

The portable inline pump kit may also comprise a spray nozzle configured to be adapted onto the fluid output port of the pump for spraying the fluid; and one of the case portions is configured to receive, frictionally engage and store the spray nozzle.

The portable inline pump kit may also comprise a hose configured to be adapted to the fluid output port of the pump and also configured as a conduit for extending the reach for providing the fluid from the pump; and one of the case portions is configured to receive, frictionally engage and store the hose.

The portable inline pump kit may also comprise a battery recharger configured for recharging the portable battery or battery pack, and one of the case portions is configured to receive, frictionally engage and store the battery recharger.

The top case portion includes a top tray configured to receive, frictionally engage and store one or more of the pump, the portable battery or battery pack, the connector, the alligator style battery connector or the cigarette lighter connector. The top case portion is configured to receive, frictionally engage and hold the top tray therein.

The bottom case portion includes a bottom tray configured to receive, frictionally engage and store one or more of the pump, the portable battery or battery pack, the connector, the alligator style battery connector or the cigarette lighter connector. The bottom case portion is configured to receive, frictionally engage and hold the bottom tray therein.

The portable inline pump kit may also comprise a waterproof fuse assembly configured electrically in relation to the pump and the battery pack so as to provide fusing functionality to protect the pump from electrical shorts.

One case portion may include a latch, and the other case portion includes a mechanism configured to receive and engage the latch for securely closing the two case portions together.

One case portion may include a handle for carrying the portable inline pump kit.

The portable inline pump kit may also comprise a hose clamp configured to clamp one end of the hose, e.g., to the fluid output port of the pump, or to some other hose connection.

By way of example, the battery or battery pack may be DC battery, including a 9.6 volt battery, and the battery charger may be a 110 or 220 volt battery charger with a plug for connecting to a 110 or 220 volt electrical outlet.

### BRIEF DESCRIPTION OF THE DRAWING

The drawing, which are not necessarily drawn to scale, includes the following Figures:

FIG. 1 is a drawing of a portable inline pump kit according to some embodiments of the present invention.

FIG. 2 is a view of a top tray of a portable inline pump kit according to some embodiments of the present invention.

FIGS. 3a and 3b are views of a bottom tray of the portable inline pump kit shown in FIG. 2 according to some embodiments of the present invention.

FIG. 4 is a view of a closed tray of the portable inline pump kit according to some embodiments of the present invention.

FIG. 5 is a view of alligator battery clips of the portable inline pump kit according to some embodiments of the present invention.

FIG. 6 is a view of a flat hose of the portable inline pump kit according to some embodiments of the present invention.

### DETAILED DESCRIPTION OF THE INVENTION

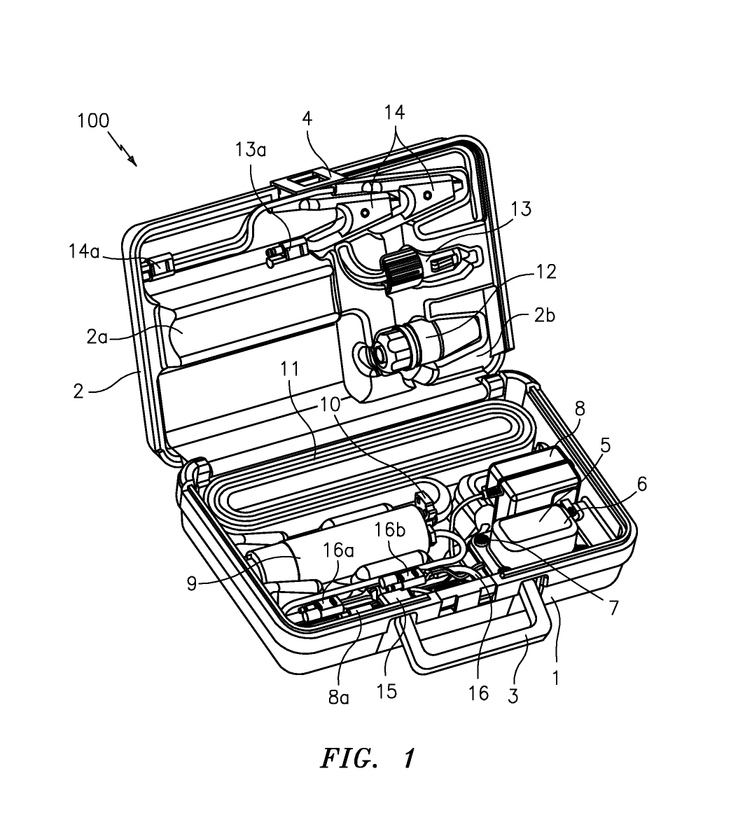

FIGS. 1-6 show a new and unique portable inline pump kit generally indicated as 100 that includes the following parts:

a case base 1 that may be blown molded,

a case lid 2 that may also be blown molded,

a case handle 3 for carrying the portable inline pump kit 100,

a case latch 4 for latching the case lid 2 to the case base 1,

a battery cover 5 that may be detachable,

a battery pack 6 (see FIG. 3b) arranged underneath the battery cover 5,

self tapping screws 7 for fastening the battery cover 5,

a battery charger 8 having a bullet connector 8a,

an inline electric pump 9 for pumping a fluid,

a hose clamp 10,

a collapsible hose 11,

a spray nozzle 12,

an auto adapter plug 13 (a.k.a. cigarette lighter connector) having a bullet connector 13a,

an alligator style battery connector 14 having a bullet connector 14a and clips 14b, 14c,

a waterproof fuse assembly 15, and

associated wiring or connector 16 having bullet connectors 16a, 16b.

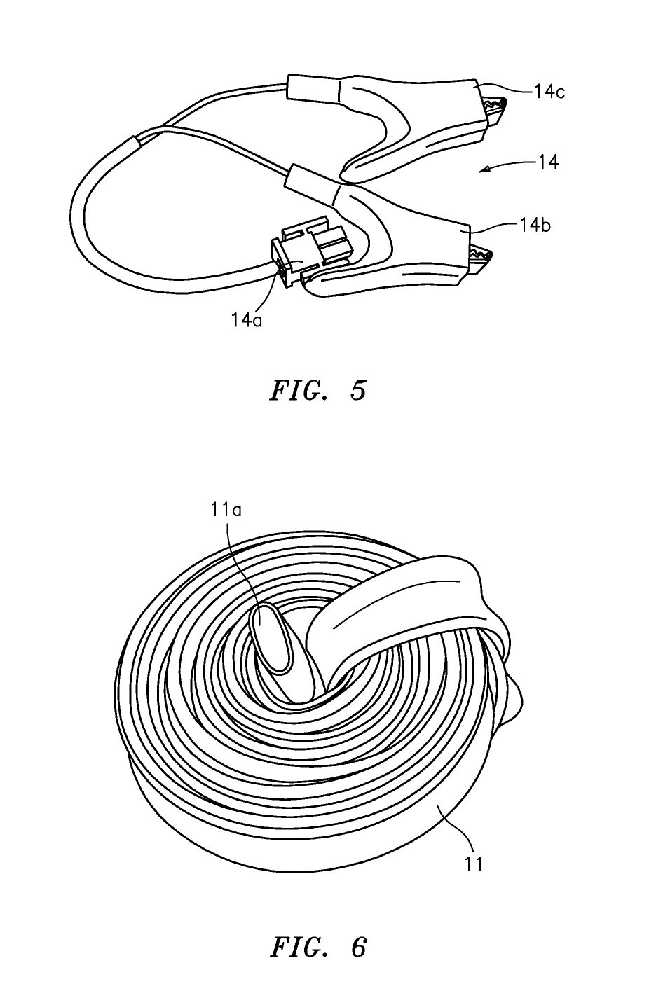

The case base 1 is hingeably coupled to the case lid 2 and may be latched with the case latch 4 for opening, closing and latching the portable inline pump kit 100. FIG. 4 shows the portable inline pump kit 100 as a closed case.

The case base 1 is configured with a molded construction in the form of a bottom tray 17 (see FIGS. 3a-3b) configured to receive, frictionally engage and store an arrangement of the battery cover 5, the battery pack 6, the self tapping screws 7, the charger 8 having a bullet connector 8a, the inline pump 9, the hose clamp 10, the collapsible hose 11, the waterproof fuse assembly 15, and the associated wiring or connection 16 having two bullet connectors 16a, 16b, as shown. The battery cover 5, the battery pack 6, the self tapping screws 7, the charger 8, the inline pump 9, the hose clamp 10, the collapsible hose 11, the waterproof fuse assembly 15, the associated wiring 16 and the bullet connectors 8a, 16a, 16b are all known in the art, and the scope of the invention is not intended to be limited to any particular type or kind either now known or later developed in the future. Alternatively, embodiments are envisioned in which the case base 1 and the bottom tray 17 are configured as one integral unit so that the case base 1 and the bottom tray are configured to form part of a one-piece molded construction.

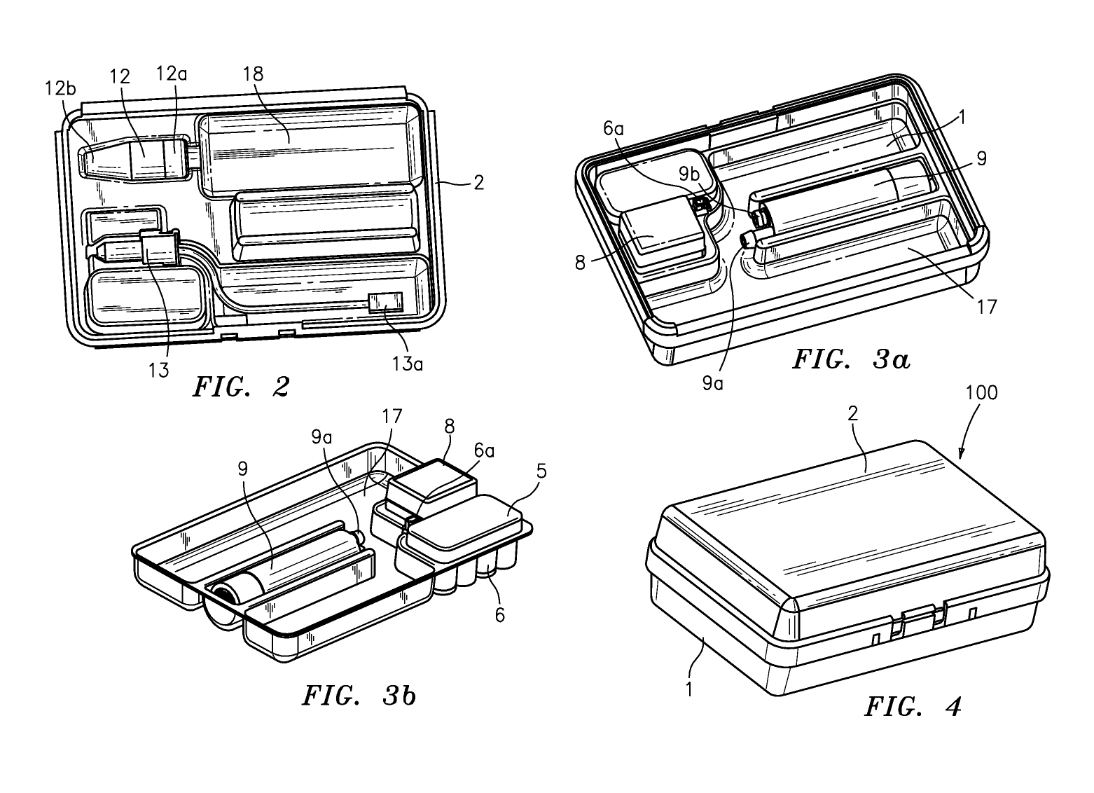

The case lid 2 is configured with a similar molded construction in the form of a top tray 18 (see FIG. 2) configured to receive, frictionally engage and store a corresponding arrangement of the spray nozzle 12, the auto adapter plug or cigarette lighter adapter 13 having a bullet connector 13a, the alligator style battery connector 14 having the bullet connector 14a and the battery clips 14b, 14c, as shown. The spray nozzle 12, the auto adapter plug 13 and the alligator style battery connector 14 are also all known in the art, and the scope of the invention is not intended to be limited to any particular type or kind either now known or later developed in the future. Alternatively, embodiments are envisioned in which the case lid 2 and the top tray 18 are configured as one integral unit so that the case lid 2 and the top tray 18 are configured to form part of a one-piece molded construction.

The scope of the invention is not intended to be limited to which of the parts listed above are arranged in the case base 1 or the case lid 2. For example, embodiments of the invention are envisioned in which the case base 1 and the case lid 2 is respectively configured with a respective different molded construction to contain a respective different arrangement of parts.

The molded constructions of the case base 1 and the case lid 2 are configured and dimensioned so that each of the aforementioned parts, including not limited to parts 6 and 8-16, are received, engaged and contained with a respective snap fit so as not to fall out when the case portions 1, 2 of the portable inline pump kit 100 are opened or closed. The molded constructions includes having portions configured and dimensioned in one case portion for receiving, engaging and retaining parts in the other case. For example, the case lid 2 has a portion 2a configured and dimensioned for receiving, engaging and retaining the pump 9 stored in the case base 1, and the case lid 2 has a portion 2b configured and dimensioned for receiving, engaging and retaining the battery recharger 8 stored in the case base 1. Techniques for providing such molded constructions having such a snap fit based on the dimension of the respective parts are known in the art, and the scope of the invention is not intended to be limited to any particular type or kind either now known or later developed in the future.

By way of example, the inline pump 9 may be capable of pumping hundreds of gallons of fluid per hour, including e.g. 280 or more gallons, based at least partly on the power in the battery pack 6 when fully charged, although the scope of the invention is not intended to be limited to the number of gallons per hours that are pumped.

The pump 9 has a quick connect fluid output port 9a (FIG. 3a) configured to couple to an end 11a of the 8′ length of collapsible hose 11. The pump 9 has a quick disconnect power input connection 9b configured to couple the pump 9 to some power source. For example, the power input connection 9b may be configured to receive a corresponding quick disconnect plug r connection, e.g. a bullet connector like 13a, that forms part of the cigarette lighter connector 13 to couple the pump to a remote cigarette lighter (not shown), e.g., in a boat, a car, or some other equipment or device. The power input connection 9b may also be configured to receive a corresponding quick disconnect plug or connection, like a bullet connector, that forms part of wiring used to couple to the pump to a connection 6a of the portable battery or battery pack 6, The power input connection 9b may also be configured to receive a corresponding quick disconnect plug or connection, e.g. a bullet connector, that forms part of the alligator style battery connector 14 having battery clips 14b, 14c used to couple the pump to terminals of a battery (not shown), including a car or boat battery. The invention is shown and described using a corresponding quick disconnect power connection in the form of a bullet connector; however, embodiments are envisioned, and the scope of the invention is intended to include, using other types or kinds of electrical connectors either now known or later developed in the future.

The hose clamp 10 may be used to further couple the hose 11 to the quick connect port 9a. The battery pack connection 6a of the battery pack 6 may also be used for electrically coupling the battery pack 6 to a corresponding quick disconnect plug or connection 8a of the battery charger 8, which is configured to couple to and recharge the battery pack 6.

The spray nozzle 12 has a connector 12a at one end configured to couple the spray nozzle 12 to the port 9a of the pump 9 for spraying out of its other end 12b fluid being pumped by the pump 9.

The portable inline pump kit 100 may also comprise the waterproof fuse assembly 15 configured electrically in relation to the pump 9 and the battery pack 6 so as to provide fusing functionality to protect the pump 9 and the battery pack 6 from electrical shorts. The present invention helps the consumer by allowing the user to transfer water, antifreeze or diesel fuel using 12 volt electricity from a vehicle battery, cigarette adaptor or an integrated rechargeable battery permanently mounted in the carry case.

### THE SCOPE OF THE INVENTION

Further still, the embodiments shown and described in detail herein are provided by way of example only; and the scope of the invention is not intended to be limited to the particular configurations, dimensionalities, and/or design details of these parts or elements included herein. In other words, a person skilled in the art would appreciate that design changes to these embodiments may be made and such that the resulting embodiments would be different than the embodiments disclosed herein, but would still be within the overall spirit of the present invention.

It should be understood that, unless stated otherwise herein, any of the features, characteristics, alternatives or modifications described regarding a particular embodiment herein may also be applied, used, or incorporated with any other embodiment described herein. Also, the drawings herein are not drawn to scale.

Although the invention has been described and illustrated with respect to exemplary embodiments thereof, the foregoing and various other additions and omissions may be made therein and thereto without departing from the spirit and scope of the present invention.

What we claim is:

1. A portable inline pump kit comprising:
a pump having a fluid output port configured to pump fluid, and having a quick disconnect power input connection configured to couple the pump to a source of power;
a portable battery or battery pack having a quick disconnect power connection configured to be coupled by associated wiring to the pump;
a connector having one corresponding quick disconnect plug or connection, including a bullet connector, configured to couple to the quick connect power input connection of the pump, and having another corresponding quick disconnect plug configured to couple to the quick disconnect power connection of the portable battery or battery pack;
an alligator style battery connector having one corresponding quick disconnect plug or connection configured to couple to the quick connect power input connection of the pump, and having a pair of alligator style battery clips configured to be coupled to terminals of a battery, including a car or boat battery;
a cigarette lighter connector having one corresponding quick disconnect plug or connection configured to couple to the quick connect power input connection of the pump, and having a cigarette lighter power adapter configured to be coupled to a remote cigarette lighter in, e.g. a boat, a car, or some other equipment or device; and
a carrying case having a top case portion hingeably coupled to a bottom case portion, wherein one case portion is configured to receive, frictionally engage and store one or more of the pump, the portable battery or battery pack, the connector, the alligator style battery connector or the cigarette lighter connector, and wherein the other case portion is configured to receive, frictionally engage and store the one or more of the pump, the portable battery or battery pack, the connector, the alligator style battery connector or the cigarette lighter connector not being stored in the one case portion.

2. The portable inline pump kit according to claim 1, wherein the portable inline pump kit further comprises a spray nozzle configured to be adapted onto the fluid output port of the pump for spraying the fluid; and one of the case portions is configured to receive, frictionally engage and store the spray nozzle.

3. The portable inline pump kit according to claim 1, wherein the portable inline pump kit further comprises a hose configured to be adapted to the fluid output port of the pump and also configured as a conduit for extending the reach for providing the fluid from the pump; and one of the case portions is configured to receive, frictionally engage and store the hose.

4. The portable inline pump kit according to claim 1, wherein the portable inline pump kit further comprises a battery recharger configured for recharging the portable battery or battery pack, and one of the case portions is configured to receive, frictionally engage and store the battery recharger.

5. The portable inline pump kit according to claim 1, wherein the top case portion includes a top tray configured to receive, frictionally engage and store one or more of the pump, the portable battery or battery pack, the connector, the alligator style battery connector or the cigarette lighter connector.

6. The portable inline pump kit according to claim 1, wherein the bottom case portion includes a bottom tray configured to receive, frictionally engage and store one or more of the pump, the portable battery or battery pack, the connector, the alligator style battery connector or the cigarette lighter connector.

7. The portable inline pump kit according to claim 1, wherein the portable inline pump kit further comprises a waterproof fuse assembly configured to provide fusing functionality to protect the pump from electrical shorts.

8. A portable inline pump kit according to claim 1, wherein the portable battery or battery pack is a DC battery, including 9.6 volt battery.

9. A portable inline pump kit according to claim 1, wherein the battery charger is about a 110 or 220 volt battery charger with a plug for connecting to a 110 or 220 volt electrical outlet.
